(19) United States
(12) Patent Application Publication
(10) Pub. No.: US 2003/0231154 A1
(43) Pub. Date: Dec. 18, 2003

(54) Liquid crystal display and driving method thereof

(75) Inventors: Seon-Young Yeo, Seoul (KR); Sung-Chul Kang, Kyungki-do (KR); Jin-Ho Ju, Seoul (KR); Jae-Hong Jeon, Kyungki-do (KR); Seok-Hyun Nam, Seoul (KR); Jin-Seob Byun, Seoul (KR)

Correspondence Address: David W. Heid, MacPherson Kwok Chen & Heid LLP, Suite 226, 1762 Technology Drive, San Jose, CA, 95110, US

(73) Assignee: SAMSUNG ELECTRONICS CO., LTD., Suwon-city (KR)

(21) Appl. No.: 10/382,977

(22) Filed: Mar. 5, 2003

(30) Foreign Application Priority Data
Mar. 6, 2002 (KR) 2002-11886

(51) Int. Cl. G09G 3/36

(52) U.S. Cl. 345/89

(57) ABSTRACT

A liquid crystal display is provided, which includes: a liquid crystal panel assembly including a first panel including a plurality of gate lines, a plurality of data lines, a plurality of thin film transistors connected to the gate lines and the data lines, and a plurality of pixel electrodes connected to the thin film transistors, and a second panel including a common electrode supplied with a common voltage having an applied value and facing the first panel; a gate driver for applying a gate-on voltage for turning on the thin film transistors to the gate lines; and a data driver for applying data voltages to the data lines, wherein the data voltages are selected from a plurality of gray voltages including black gray voltages and white gray voltages, and the applied value of the common voltage is determined such that subtraction of a first optimal value of the common voltage for the black gray voltages from a second optimal value of the common voltage for the white gray voltages is substantially equal to or less than a first predetermined value.

### BACKGROUND OF THE INVENTION

(a) Field of the Invention

The present invention relates to a liquid crystal display and a driving method thereof.

(b) Description of Related Art

Flat panel displays such as liquid crystal displays (LCDs) have been developed and substituted for cathode ray tubes (CRTs) since they are suitable for recent personal computers and televisions, which become lighter and thinner.

An LCD representing the flat panel displays includes two panels provided with two kinds of field generating electrodes such as pixel electrodes and a common electrode and a liquid crystal layer with dielectric anisotropy interposed therebetween. The variation of the voltage difference between the field generating electrodes, i.e., the variation in the strength of an electric field generated by the electrodes changes the transmittance of the light passing through the LCD, and thus desired images are obtained by controlling the voltage difference between the electrodes. A typical LCD includes thin film transistors (TFTs) as switching elements for controlling the voltages to be applied to the pixel electrodes.

An LCD displays moving pictures as well as still images. In displaying moving pictures, the LCD has a serious problem of afterimage due to characteristics of liquid crystal. The afterimage is a phenomenon that an image of a previous frame remains without completely fading out to influence on an image of a current frame. The afterimage is resulted from various factors such as the concentration of ion impurity in the liquid crystal layer, strength of alignment force, kickback phenomenon, and so forth.

For example, impurity ions in the liquid crystal layer, when the concentration of ion impurity is not appropriate, are often adsorbed to an alignment layer of polyimide contacting the liquid crystal layer, and cause a remaining DC voltage even in absence of voltages applied to field generating electrodes. The remaining DC voltage keeps the arrangement of the liquid crystal molecules to be fixed, thereby causing the afterimage.

For removing the afterimage, the concentration of ion impurity in the liquid crystal layer is optimized, the alignment force is strengthened, the response time of the liquid crystal molecules are improved by reducing the kickback voltage, and so forth.

In the meantime, the polarity of the voltages across the liquid crystal layer, i.e., the polarity of data voltages applied to the pixel electrodes with respect to a common voltage applied to the common electrode is periodically inverted for preventing the degradation of the liquid crystal layer due to long-time application of a unidirectional electric field. Accordingly, there are a pair of data voltages for a given gray or a given brightness. When displaying an image, a pair of data voltages for a gray are applied to a pixel in turn.

However, the data voltages for a gray may not give the same brightness due to several reasons such as the above-described remaining DC voltages, thereby resulting in the afterimage. Therefore, there is a problem that the common voltage may be adjusted to have an optimal value for the gray, which gives equal brightness for a pair of data voltages for the gray. Actually, there is another problem that the optimal values of the common voltage for different grays are not equal. For example, the optimal value for the white gray, i.e., the brightest gray is very different from that for the black gray, i.e., the darkest gray.

### SUMMARY OF THE INVENTION

According to an aspect of the present invention, a liquid crystal display is provided, which includes: a liquid crystal panel assembly including a first panel including a plurality of gate lines, a plurality of data lines, a plurality of thin film transistors connected to the gate lines and the data lines, and a plurality of pixel electrodes connected to the thin film transistors, and a second panel including a common electrode supplied with a common voltage having an applied value and facing the first panel; a gate driver for applying a gate-on voltage for turning on the thin film transistors to the gate lines; and a data driver for applying data voltages to the data lines, wherein the data voltages are selected from a plurality of gray voltages including black gray voltages and white gray voltages, and the applied value of the common voltage is determined such that subtraction of a first optimal value of the common voltage for the black gray voltages from a second optimal value of the common voltage for the white gray voltages is substantially equal to or less than a first predetermined value.

It is preferable that the subtraction of the first optimal value of the common voltage from the applied value of the common voltage is substantially equal to or less than a second predetermined value.

The first and/or the second predetermined value is preferably positive, and the liquid crystal display is preferably in normally black mode.

Preferably, the liquid crystal display further includes a common voltage generator for generating and providing the common voltage for the common electrode, a gray voltage generator for generating and providing the gray voltages for the data driver, or a signal generator for controlling the gate driver and the data driver and providing a plurality of image data to be converted into the data voltages by the data driver.

According to another aspect of the present invention, a liquid crystal display is provided, which includes: a plurality of pixels, each pixel including a liquid crystal capacitor having a first terminal supplied with a common voltage having an applied value and a second terminal supplied with data voltages and a switching element transmitting the data voltages to the liquid crystal capacitor; and a data driver for supplying the data voltages to the switching elements, wherein the data voltages are selected from a plurality of gray voltages including white gray voltages and black gray voltages, and subtraction of a first optimal value of the common voltage for the black gray voltages from the applied value of the common voltage is substantially equal to or less than a first predetermined value.

It is preferable that the subtraction of the first optimal value from a second optimal value of the common voltage for the white gray voltages is substantially equal to or less than a second predetermined value.

The first and/or the second predetermined value is preferably positive, and the liquid crystal display is preferably in normally black mode.

Preferably, the liquid crystal display further includes a gate driver for applying signals to the switching elements to be turned on, a common voltage generator for generating and providing the common voltage for the liquid crystal capacitor, a gray voltage generator for generating and providing the gray voltages for the data driver, or a signal generator for controlling the gate driver and the data driver and providing a plurality of image data to be converted into the data voltages by the data driver.

A method of driving a liquid crystal display including a plurality of pixels, each pixel including a liquid crystal capacitor and a switching element is provided, which includes: applying a common voltage having an applied value to the liquid crystal capacitor; generating a plurality of gray voltages including black gray voltages and white gray voltages; converting image data into data voltages selected from the gray voltages; applying a gate-on voltage to the switching elements to be turned on; and applying the data voltages to the pixels via the switching elements, wherein the applied value of the common voltage is determined such that at least one of following relations are satisfied:

(1) a first optimal value of the common voltage for the white gray voltages minus a second optimal value of the common voltage for the black gray voltages is substantially equal to or less than a first predetermined value; and

(2) the applied value of the common voltage minus the second optimal value is substantially equal to or less than a second predetermined value.

The first or the second predetermined value is preferably positive, and the liquid crystal display is preferably in normally black mode.

### BRIEF DESCRIPTION OF THE DRAWINGS

The above and other advantages of the present invention will become more apparent by describing preferred embodiments thereof in detail with reference to the accompanying drawings in which:

FIG. 1 is a block diagram of an LCD according to an embodiment of the present invention;

FIG. 2 is an equivalent circuit diagram of a pixel of an LCD according to an embodiment of the present invention;

FIG. 3 is a graph showing brightness as function of a common voltage for a pair of gray voltages; and

FIG. 4 shows optimal values of a common voltage for a black gray and a white gray.

### DETAILED DESCRIPTION OF THE PREFERRED EMBODIMENTS

The present invention now will be described more fully hereinafter with reference to the accompanying drawings, in which preferred embodiments of the inventions invention are shown. The present invention may, however, be embodied in many different forms and should not be construed as limited to the embodiments set forth herein.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

Now, LCDs and driving methods thereof according to embodiments of this invention will be described in detail with reference to the accompanying drawings.

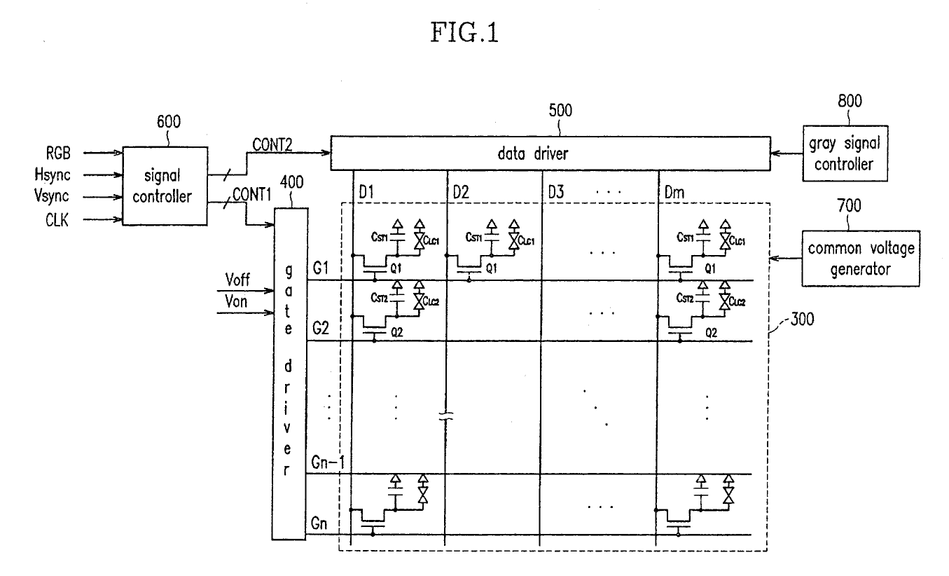

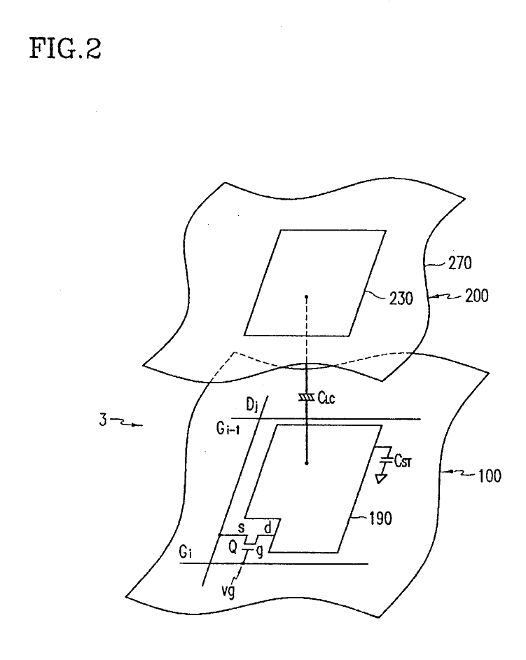

FIG. 1 is a block diagram of an LCD according to an embodiment of the present invention, and FIG. 2 is an equivalent circuit diagram of a pixel of an LCD according to an embodiment of the present invention.

Referring to FIG. 1, an LCD according to an embodiment of the present invention includes a liquid crystal panel assembly 300, a gate driver 400, a data driver 500 and a common voltage generator 700 which are connected to the panel assembly 300, a gray voltage generator 800 connected to the data driver 500, and a signal controller 600 controlling the above units.

In circuital view, the panel assembly 300 includes a plurality of display signal lines G₁-Gₙ and D₁-Dₘ and a plurality of pixels connected thereto and arranged substantially in a matrix. In structural view, the liquid crystal panel assembly 300 includes a lower panel 100, an upper panel 200 and a liquid crystal layer 3 interposed therebetween.

The display signal lines G₁-Gₙ and D₁-Dₘ are provided on the lower panel 100 and include a plurality of data lines D₁-Dₘ transmitting data signals and a plurality of gate lines G₁-Gₙ transmitting gate signals (or scanning signals). The gate lines G₁-Gₙ extend substantially in a row direction and are substantially parallel to each other, while the data lines D₁-Dₘ extend substantially in a column direction and are substantially parallel to each other.

Each pixel includes a switching element Q connected to the display signal lines G₁-Gₙ and D₁-Dₘ, a liquid crystal capacitor C_{LC} and a storage electrode C_{ST}, which are connected to the switching element Q. The storage electrode C_{ST} may be omitted if unnecessary.

The switching element Q such as TFT is provided on the lower panel 100 and has three terminals, a control terminal connected to one of the gate lines G₁-Gₙ, an input terminal connected to one of the data lines D₁-Dₘ, and an output terminal connected to both the liquid crystal capacitor C_{LC} and the storage capacitor C_{ST}.

The liquid crystal capacitor C_{LC}includes a pixel electrode 190 on the lower panel 100, a common electrode 270 on the upper panel 200, and the liquid crystal layer 3 as a dielectric between the electrodes 190 and 270. In addition, there are alignment layers (not shown) on the pixel electrode 190 and the common electrode 270. The alignment layers also function as a dielectric between the electrodes 190 and 270, and there may exist impurity ions adsorbed to the surface of the alignment layers, which may cause an additional voltage difference to the voltage difference between the pixel electrode 190 and the common electrode 270. The pixel electrode 190 is connected to the switching element Q, and the common electrode 270 covers the entire surface of the upper panel 100 and is supplied with a common voltage V_{com}. Alternatively, both the pixel electrode 190 and the common electrode 270, which have shapes of bars or stripes, are provided on the lower panel 100.

The storage capacitor C_{ST}, an auxiliary capacitor for the liquid crystal capacitor C_{LC} includes the pixel electrode 190 and a separate signal line (not shown), which is provided on the lower panel 100, overlaps the pixel electrode 190 via an insulator, and is supplied with a predetermined voltage such as the common voltage V_{com}. Alternatively, the storage capacitor C_{ST} includes the pixel electrode 190 and an adjacent gate line called a previous gate line, which overlaps the pixel electrode 190 via an insulator.

For color display, each pixel represents its own color by providing red, green or blue color filter 230 on an area occupied by the pixel electrode 190. Referring to FIG. 2, the color filter 230 is located in the corresponding area of the upper panel 200, but it may be provided on or under the pixel electrode 190 on the lower panel 100.

Referring to FIG. 1 again, the gray voltage generator 800 generates two sets of a plurality of gray voltages related to the transmittance of pixels. One of the two sets has a positive value with respect to the common voltage V_{com}, while the other has a negative value with respect to the common voltage V_{com}.

The common voltage generator 700 generates the common voltage V_{com} having a predetermined value and applies the common voltage V_{com} to the common electrode 270 of the upper panel 200. The predetermined applied value of the common voltage V_{com} will be described later in detail.

The gate driver 400 is connected to the gate lines G₁-Gₙ of the panel assembly 300 and applies the gate signals from an external source to the gate lines G₁-Gₙ, each gate signal being a combination of a gate-on voltage Vₒₙ and a gate-off voltage V_{off}, while the data driver 500 is connected to the data lines D₁-Dₙ of the panel assembly 300, selects some of the gray voltages from the gray voltage generator 800, and apply the selected gray voltages (i.e., the data voltages) to the data lines D₁-Dₙ.

The data voltage is applied to the pixel electrode 190 of the liquid crystal capacitor C_{LC} via the switching element Q, and the voltage difference between the data voltage and the common voltage V_{com} charges the liquid crystal capacitor C_{LC} to have a pixel voltage, i.e., the charged voltage across the liquid crystal capacitor C_{LC}.

The orientations of liquid crystal molecules in the liquid crystal capacitor C_{LC} are changed by the change of the pixel voltage, which in turn changes the polarization of light passing through the liquid crystal layer 3. The change of the light polarization results in the variation of the transmittance of the light by a polarizer or polarizers (not shown) attached to at least one of the panels 100 and 200.

In the meantime, the gate driver 400 and the data driver 500 operate under the control of the signal controller 600 connected thereto and located external to the panel assembly 300. The operation will be described in detail.

The signal controller 600 is supplied from an external graphic controller (not shown) with image signals R, G and B and input control signals for controlling the image signals R, G and B. Exemplary input control signals are a vertical synchronization signal V_{sync} for distinguishing frames, a horizontal synchronization signal H_{sync} for distinguishing data rows, a main clock CLK basically required for signal processing, a data enable signal DE for distinguishing valid image signals, etc. After generating a plurality of gate control signals CONT1 and a plurality of data control signals CONT2 on the basis of the input control signals and processing the image signals R, G and B to be suitable for the liquid crystal panel assembly 300, the signal controller 600 provides the gate control signals CONT1 for the gate driver 400, and the processed image data R′, G′ and B′ and the data control signals CONT2 for the data driver 430.

The gate control signals CONT1 include a vertical synchronization start signal STV for instructing to begin outputting gate-on pulses (i.e., gate-on voltage (Vₒₙ) sections of the gate signals), a gate clock signal CPV for controlling the output time of the gate-on pulses and an output enable signal OE for defining the widths of the gate-on pulses.

The data control signals CONT2 include a horizontal synchronization start signal STH for informing the beginning of output of the image data R′, G′ and B′, a load signal LOAD for instructing to apply the data voltages to the data lines, an inversion signal RVS for inverting polarity of the data voltages with respect to the common voltage V_{com} (simply referred to as “the polarity of the data voltages” hereinafter), a data clock signal HCLK basically required for processing the image data, and so on.

Responsive to the data control signals CONT2 from the signal controller 600, the data driver 500 sequentially receives the image data R′, G′ and B′ for a row of the pixels and converts the image data R′, G′ and B′ into analog data voltages selected among the gray voltages from the gray voltage generator 800 corresponding to the image data R′, G′ and B′.

The gate driver 400 sequentially applies the gate-on voltages Vₒₙ to the gate lines G₁-Gₙ, thereby sequentially turning on the switching elements Q connected thereto in responsive to the gate control signals CONT1 from the signals controller 600, During one horizontal period (referred to as “1H”), which is a turning on period of a row of the switching elements Q connected to one gate line supplied with the gate-on voltage Vₒₙ and is substantially equal to one period of the horizontal synchronization signal H_{sync}, the data enable signal DE and the gate clock signal CPV, the data driver 500 supplies the data voltages to the data lines D₁-Dₘ, which in turn are applied to the pixels via the turned-on switching elements Q.

By repeating this procedure, all the gate lines G₁-Gₙ are supplied with the gate-on voltage Vₒₙ during one frame, and thus the data voltages are applied to all the pixels. Once a frame is finished and the next frame starts, the inversion signal RVS from the signal controller 600 to the data driver 500 is controlled such that the polarity of a data voltage applied to a pixel is opposite to that in the previous frame (referred to as “frame inversion”). During one frame, the polarity of the data voltages via a data line may be different (referred to as “line inversion”) and/or the polarity of the data voltages applied to the pixels in a row may be different (referred to as “dot inversion”).

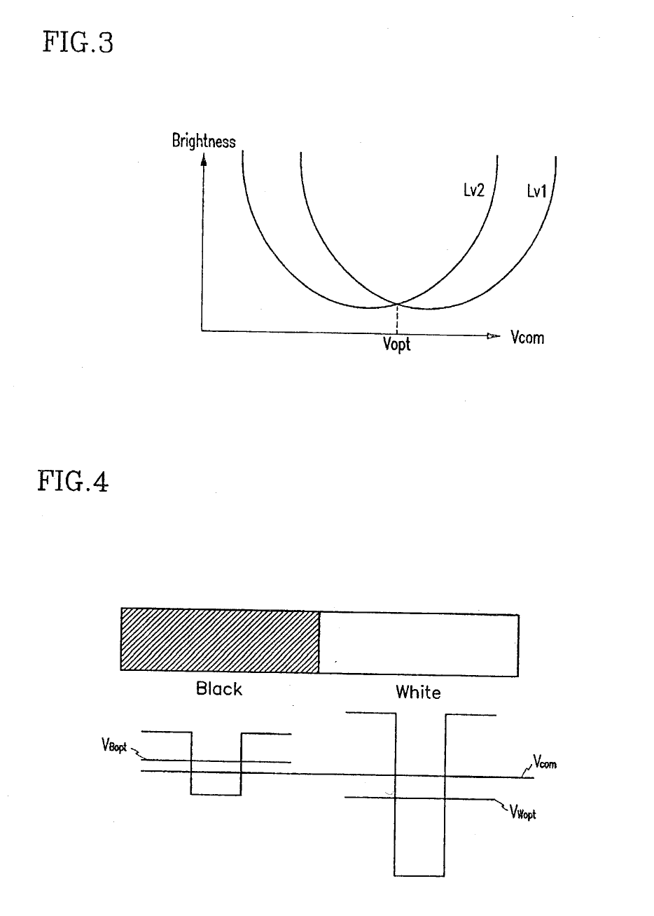

As described above, the common voltage V_{com} applied to the common electrode 270 has a predetermined value, which is now described in detail with reference to FIGS. 3 and 4.

For a given gray, a pair of gray voltages such as those having opposite polarities with respect to the common voltage V_{com} are generated from the gray voltage generator 800. An optimal value of the common voltage V_{com} for the given gray is defined as a value such that a pair of gray voltages for the gray give equal brightness or equal pixel voltage.

FIG. 3 shows brightness as function of a common voltage V_{com} for a pair of gray voltages for a gray, which have respective values V1 and V2.

The brightness L_{V1}(V_{com}) of an LCD supplied with a data voltage of V1 is compared with the brightness L_{V2}(V_{com}) of the LCD supplied with a data voltage of V2. If the brightness L_{V1} and L_{V2} has an equal value when V_{com}=Vₒₚₜ then Vₒₚₜ is determined as an optimal value of the common voltage V_{com} for that gray.

For example, for a given gray, it is assumed that the corresponding gray voltages have respective values of 5V and −5V. If the common voltage V_{com} applied to the common electrode 270 has a value optimal to the gray, the brightness of the LCD under the application of a data voltage with 5V is substantially the same as the brightness of the LCD under the application of a data voltage with −5V.

An optimal value V_{Bopt} of the common voltage V_{com} for a white gray (referred to as “optimal white common value”) and an optimal value V_{Wopt} of the common voltage V_{com} for a black gray (referred to as “optimal black common value”) are defined by using the pixel voltages as shown in FIG. 4. FIG. 4 shows a value Vₐₚₚ of the common voltage V_{com} actually applied to the common electrode 270 (referred to as “applied common value”) and the optimal black common value V_{Bopt} and the optimal white common value V_{Wopt}. The optimal black common value V_{Bopt} is determined such that the pixel voltages for both the gray voltages of the black gray are substantially equal to each other, while the optimal white common value V_{Wopt} is determined such that the pixel voltages for both the gray voltages of the white gray are substantially equal to each other.

The two definitions shown in FIGS. 3 and 4 are identical since the brightness and the pixel voltage with either polarity have one-to-one correspondence.

The afterimage of a normally black mode LCD with 64 grays was measured as function of an optimal black common value V_{Bopt} for the darkest gray (1G), an optimal white common value V_{Wopt} for the brightest gray (64G) and an applied common value Vₐₚₚ actually applied to a common electrode 270. The measurement was performed eight times 1PT-8PT with different sets of voltages. The measured results are shown in TABLE 1, which also illustrates the difference between the optimal white common value V_{Wopt} and the optimal black common value V_{Bopt} and the relative levels of the optimal white common value V_{Wopt}, the optimal black common value V_{Bopt}, and the applied common value Vₐₚₚ.

TABLE 1

| | 1 PT | 2 PT | 3 PT | 4 PT | 5 PT | 6 PT | 7 PT | 8 PT |
|---|---|---|---|---|---|---|---|---|
| V_{Bopt} (V) | 4.00 | 4.04 | 4.01 | 4.06 | 4.31 | 4.12 | 4.12 | 4.14 |
| V_{Wopt} (V) | 4.11 | 4.06 | 4.03 | 4.09 | 4.12 | 4.05 | 4.05 | 4.07 |
| Vₐₚₚ (V) | 4.07 | 3.94 | 3.95 | 4.11 | 4.16 | 4.10 | 4.03 | 4.16 |
| V_{Wopt}- | 110 | 20 | 20 | 30 | −190 | −70 | −70 | −70 |
| V_{Bopt} (mV) | | | | | | | | |
| Relative | V_{Wopt} | V_{Wopt} | V_{Wopt} | Vₐₚₚ | V_{Bopt} | V_{Bopt} | V_{Bopt} | V_{Bopt} |
| Level | Vₐₚₚ | V_{Bopt} | V_{Bopt} | V_{Wopt} | Vₐₚₚ | Vₐₚₚ | V_{Wopt} | Vₐₚₚ |
| | V_{Bopt} | Vₐₚₚ | Vₐₚₚ | V_{Bopt} | V_{Wopt} | V_{Wopt} | Vₐₚₚ | V_{Wopt} |
| After- | 2.33 | 1.32 | 1.41 | 1.70 | 1.14 | 1.16 | 0.91 | 1.30 |
| image | | | | | | | | |

Referring to TABLE1, the cases 1PT-8PT are classified into two sets based on the relative level of the optimal white common value V_{Wopt} and the optimal black common value V_{Bopt}, a first set including the cases 1PF-4PT where the optimal white common value V_{Wopt} is larger than the optimal black common value V_{Bopt}, and a second set including the cases 5PT-8PT where the optimal white common value V_{Wopt} is smaller than the optimal black common value V_{Bopt}.

Comparing the first set 1PT-4PT and the second set 5PT-8PT, the afterimage was relatively serious in the first set 1PT-4PT.

Each set is classified into two subsets based on the relative level of the applied common value Vₐₚₚ and the optimal black common value V_{Bopt}. For example, the first set 1PT-4PT is classified into a first subset including the cases 1PT and 4PT where the applied common value Vₐₚₚ is larger than the optimal black common value V_{Bopt}, and a second subset including the cases 2FT and 3PT where the applied common value Vₐₚₚ is smaller than the optimal black common value V_{Bopt}. Similarly, the second set 1PT-4PT is classified into a first subset including the case 8PT where the applied common value Vₐₚₚ is larger than the optimal black common value V_{Bopt}, and a second subset including the cases 5PT-7PT where the applied common value Vₐₚₚ is smaller than the optimal black common value V_{Bopt}.

Comparing the first subset 1PT and 4PT; and 8PT with the second subset 2PT and 3PT; and 5-7PT in each set, the afterimage was relatively serious in the first subset 1PT and 4PT; and 8PT.

In addition, among the first set 1PT-4PT, the afterimage was very serious (about 2.33) in the case 1PT where the difference between the optimal white common value V_{Wopt} and the optimal black common value V_{Bopt} is the largest (about 110 mV).

Therefore, Applicants concluded that the afterimage is effectively reduced when:

V_{Wopt}−V_{Bopt}≦a predetermined (positive) value (Relation 1); and/or

Vₐₚₚ−V_{Bopt}≦a predetermined (positive) value (Relation 2).

The predetermined value is preferably about 50 mV from TABLE 1, but it is not confined to this value.

To summarize, the afterimage is least generated when the subtraction of the optimal value V_{Bopt} of the common voltage V_{com} for the black gray from the optimal value V_{Wopt} of the common voltage V_{com} for the white gray is equal to or smaller than a predetermined positive value as shown in Relation 1, and the subtraction of the optimal value V_{Bopt} of the common voltage V_{com} for the black gray from the applied value Vₐₚₚ of the common voltage V_{com} is equal to or smaller than a predetermined positive value as shown in Relation 2.

The above-described relations are substantially adaptable to a normally white LCD except for the use of the terms “black” and “white”.

Therefore, the afterimage, which is a serious factor in displaying moving pictures, is effectively removed by adjusting the optimal black common value, the optimal white common voltage and the applied common value or the gray voltages such as the white gray voltages and the black gray voltages to satisfy the above-identified relations.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A liquid crystal display comprising:
a liquid crystal panel assembly including a first panel including a plurality of gate lines, a plurality of data lines, a plurality of thin film transistors connected to the gate lines and the data lines, and a plurality of pixel electrodes connected to the thin film transistors, and a second panel including a common electrode supplied with a common voltage having an applied value and facing the first panel;
a gate driver for applying a gate-on voltage for turning on the thin film transistors to the gate lines; and
a data driver for applying data voltages to the data lines,
wherein the data voltages are selected from a plurality of gray voltages including black gray voltages and white gray voltages, and the applied value of the common voltage is determined such that subtraction of a first optimal value of the common voltage for the black gray voltages from a second optimal value of the common voltage for the white gray voltages is substantially equal to or less than a first predetermined value.

2. The liquid crystal display of claim 1, wherein the first predetermined value is positive.

3. The liquid crystal display of claim 1, wherein subtraction of the first optimal value of the common voltage from the applied value of the common voltage is substantially equal to or less than a second predetermined value.

4. The liquid crystal display of claim 3, wherein the second predetermined value is positive.

5. The liquid crystal display of claim 1, wherein the liquid crystal display is in normally black mode.

6. The liquid crystal display of claim 1, further comprising a common voltage generator for generating and providing the common voltage for the common electrode.

7. The liquid crystal display of claim 1, further comprising a gray voltage generator for generating and providing the gray voltages for the data driver.

8. The liquid crystal display of claim 1, further comprising a signal generator for controlling the gate driver and the data driver and providing a plurality of image data to be converted into the data voltages by the data driver.

9. A liquid crystal display comprising:
a plurality of pixels, each pixel including a liquid crystal capacitor having a first terminal supplied with a common voltage having an applied value and a second terminal supplied with data voltages and a switching element transmitting the data voltages to the liquid crystal capacitor; and
a data driver for supplying the data voltages to the switching elements,
wherein the data voltages are selected from a plurality of gray voltages including white gray voltages and black gray voltages, and subtraction of a first optimal value of the common voltage for the black gray voltages from the applied value of the common voltage is substantially equal to or less than a first predetermined value.

10. The liquid crystal display of claim 9, wherein the first predetermined value is positive.

11. The liquid crystal display of claim 9, wherein subtraction of the first optimal value from a second optimal value of the common voltage for the white gray voltages is substantially equal to or less than a second predetermined value.

12. The liquid crystal display of claim 11, wherein the second predetermined value is positive.

13. The liquid crystal display of claim 9, wherein the liquid crystal display is in normally black mode.

14. The liquid crystal display of claim 9, further comprising a common voltage generator for generating and providing the common voltage for the liquid crystal capacitor.

15. The liquid crystal display of claim 9, further comprising a gray voltage generator for generating and providing the gray voltages for the data driver.

16. The liquid crystal display of claim 9, further comprising a gate driver for applying signals to the switching elements to be turned on.

17. The liquid crystal display of claim 16, further comprising a signal generator for controlling the gate driver and the data driver and providing a plurality of image data to be converted into the data voltages by the data driver.

18. A method of driving a liquid crystal display including a plurality of pixels, each pixel including a liquid crystal capacitor and a switching element, the method comprising:
applying a common voltage having an applied value to the liquid crystal capacitor;
generating a plurality of gray voltages including black gray voltages and white gray voltages;
converting image data into data voltages selected from the gray voltages;
applying a gate-on voltage to the switching elements to be turned on; and
applying the data voltages to the pixels via the switching elements,
wherein the applied value of the common voltage is determined such that at least one of following relations are satisfied:
(1) a first optimal value of the common voltage for the white gray voltages minus a second optimal value of the common voltage for the black gray voltages is substantially equal to or less than a first predetermined value; and
(2) the applied value of the common voltage minus the second optimal value is substantially equal to or less than a second predetermined value.

19. The method of claim 18, wherein the first or the second predetermined value is positive.

20. The liquid crystal display of claim 18, wherein the liquid crystal display is in normally black mode.
